(19) United States
(12) Patent Application Publication
(10) Pub. No.: US 2021/0139032 A1
(43) Pub. Date: May 13, 2021

(54) Device for Controlling Vehicle and Method for Controlling Vehicle Using the Same

(71) Applicants: Hyundai Motor Company, Seoul (KR); Kia Motors Corporation, Seoul (KR)

(72) Inventor: Hyoung Muk Lim, Suwon-si (KR)

(21) Appl. No.: 17/009,240

(22) Filed: Sep. 1, 2020

(30) Foreign Application Priority Data
Nov. 7, 2019 (KR) 10-2019-0141878

(51) Int. Cl. B60W 30/18; B60W 40/105; B60W 40/13; B60W 40/09; B60W 40/06; B60W 50/14

(52) U.S. Cl. CPC B60W 30/181; B60W 40/105; B60W 40/13; B60W 40/09; B60W 40/06; B60W 2540/049; B60W 2552/00; B60W 2530/20; B60W 2520/00; B60W 2300/10; B60W 50/14

(57) ABSTRACT

A vehicle control device includes a vehicle sensing device configured to sense information about a vehicle, the information including a velocity and a weight of the vehicle, a traveling pattern generator configured to generate a traveling pattern of a driver in consideration of a vehicle state based on the velocity and the weight, a road condition based on a traveling route, and a driving habit of the driver traveling the traveling route, a slowing down length calculator configured to calculate a slowing down length weight value based on the weight and the traveling pattern, and calculate a slowing down length of the vehicle based on the traveling pattern and the slowing down length weight value, and a user interface configured to inform the driver of deceleration information based on the slowing down length.

### CROSS-REFERENCE TO RELATED APPLICATIONS

This application claims priority to Korean Patent Application No. 10-2019-0141878, filed in the Korean Intellectual Property Office on Nov. 7, 2019, which application is hereby incorporated herein by reference.

### TECHNICAL FIELD

The present disclosure relates to a device for controlling a vehicle and a method for controlling the vehicle using the same.

### BACKGROUND

Installation of an AV/navigation in a vehicle for a purpose of traffic information usage, broadcast watching, or the like is increasing and becoming common.

In one example, a weight of the vehicle, in particular, a weight of a commercial vehicle may have a lot of influence on traveling, and a slowing down length may vary depending on a loading amount of the vehicle.

In a case of a commercial vehicle driver, it is effective to estimate a re-acceleration time in consideration of the influence based on the weight of the vehicle, and to perform an appropriate deceleration without stopping as much as possible.

However, a navigation guide of a conventional vehicle provides road guidance without considering the weight of the commercial vehicle and a driving habit.

Therefore, it is necessary to vary the slowing down length depending on the influence of the loading amount on the vehicle, and there is a need for a method for controlling the vehicle that may perform the appropriate deceleration without stopping as much as possible in consideration of a re-acceleration time.

### SUMMARY

The present disclosure relates to a device for controlling a vehicle and a method for controlling the vehicle using the same. Particular embodiments relate to a device for controlling a vehicle and a method for controlling the vehicle using the same in consideration of a loading amount.

Embodiments of the present disclosure can solve problems occurring in the prior art while advantages achieved by the prior art are maintained intact.

An embodiment of the present disclosure provides a device and a method for controlling a vehicle that may perform appropriate deceleration in consideration of an effect on a weight of the vehicle and a re-acceleration time.

Another embodiment of the present disclosure provides proper guidance considering a traveling pattern of a driver based on a loading amount and a traveling situation or environment.

Another embodiment of the present disclosure provides a device and a method for controlling a vehicle that may store and update a traveling pattern of a driver in consideration of a tire condition of the vehicle, road surface information, road information, weather information, and the like.

Therefore, an appropriate guide distance may be provided by considering an ordinary traveling pattern of a driver and learning the pattern based on a weight and a situation, so that a driver may travel more comfortably and safely.

The technical problems to be solved by embodiments of the present inventive concept are not limited to the aforementioned problems, and any other technical problems not mentioned herein will be clearly understood from the following description by those skilled in the art to which the present disclosure pertains.

According to an embodiment of the present disclosure, a vehicle control device for providing information associated with traveling may include a vehicle sensing device for sensing information about a vehicle, including a velocity and a weight of the vehicle, a traveling pattern generator for generating a traveling pattern of a driver in consideration of a vehicle state based on the velocity and the weight, a road condition based on a traveling route, and a driving habit of the driver traveling the traveling route, a slowing down length calculator for calculating a slowing down length weight value based on the weight and the traveling pattern, and for calculating a slowing down length of the vehicle based on the traveling pattern and the slowing down length weight value, and a user interface for informing the driver of deceleration information based on the slowing down length.

In one embodiment, the slowing down length calculator may adjust the slowing down length weight value based on an actual slowing down length of the driver.

In one embodiment, the traveling pattern generator may update the traveling pattern by assigning a weight value to a parameter constituting the traveling pattern based on the adjusted weight value.

In one embodiment, the traveling pattern generator may determine a pattern similarity based on the adjusted weight value and the parameter weight value, and update the traveling pattern based on the similarity.

In one embodiment, the vehicle control device may further include an environment sensing device for sensing an external environment of the vehicle, wherein the slowing down length calculator may calculate the slowing down length weight value in consideration of the sensed external environment.

In one embodiment, information about a tire condition and a road surface condition sensed by the vehicle sensing device or the environment sensing device may be obtained, wherein the slowing down length calculator may derive a friction coefficient for a vehicle brake based on the tire condition and the road surface condition, and calculate a deceleration weight value based on the derived friction coefficient.

In one embodiment, the slowing down length calculator may determine whether there is the same or similar traveling pattern among previously stored traveling patterns when the vehicle enters a deceleration section requiring deceleration, and calculate the slowing down length based on a slowing down length weight value applied to the same or similar traveling pattern.

In one embodiment, the user interface may inform the driver of a deceleration time point on the traveling route.

In one embodiment, when the vehicle is a bus, the weight may be sensed based on the number of passengers in the bus.

In one embodiment, the slowing down length calculator may calculate a deceleration weight value and the slowing down length when the vehicle enters a deceleration section requiring deceleration and deceleration by the driver is not performed.

According to another embodiment of the present disclosure, a vehicle control method for providing information associated with traveling includes sensing information about a vehicle, including a velocity and a weight of the vehicle, generating a traveling pattern of a driver in consideration of a vehicle state based on the velocity and the weight, a road condition based on a traveling route, and a driving habit of the driver traveling the traveling route, calculating a slowing down length weight value based on the weight and the traveling pattern, calculating a slowing down length of the vehicle based on the traveling pattern and the slowing down length weight value, and informing the driver of deceleration information based on the slowing down length.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a control block diagram illustrating a configuration of a vehicle control device according to an embodiment of the present disclosure;

FIG. 2 is a view for illustrating a slowing down length change based on a vehicle weight according to an embodiment of the present disclosure;

FIG. 3 is a control flowchart illustrating a vehicle control method according to another embodiment of the present disclosure;

FIG. 4 is a control flowchart illustrating a vehicle control method according to another embodiment of the present disclosure; and

FIG. 5 is a control flowchart illustrating a traveling pattern learning method according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiments of the present disclosure, a detailed description of the related known configuration or function will be omitted when it is determined that it interferes with the understanding of the embodiments of the present disclosure.

In describing the components of the embodiments according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in detail with reference to FIGS. 1 to 5.

FIG. 1 is a control block diagram illustrating a configuration of a vehicle control device according to an embodiment of the present disclosure.

Referring to FIG. 1, a vehicle control device 100 according to an embodiment of the present disclosure may be implemented inside a vehicle. In this connection, the vehicle control device 100 may be integrally formed with internal control units of the vehicle, or may be implemented as a separate device and connected to the control units of the vehicle by separate connection means.

As shown, the vehicle control device 100 may include a vehicle sensing device no, an environment sensing device 120, a traveling pattern generator 130, a slowing down length calculator 140 and a user interface iso.

In the present embodiment, deriving a slowing down length based on deceleration in consideration of a weight of the vehicle will be described as an example. Following descriptions may be similarly applied when acceleration of the vehicle is required, for example, when shifting for the acceleration is required, such as when traveling on a slope.

The vehicle sensing device no acquires various information associated with the vehicle and senses information about the vehicle including a speed and the weight of the vehicle. To this end, the vehicle sensing device no may include a temperature sensor, a front sensor, a brake sensor, and a sensing device that may identify the weight of the vehicle, in particular, the weights of cargo on board and passengers of a commercial vehicle or a bus. The vehicle sensing device no may include a weight sensor, and may include an input device for inputting the weight of the cargo to the vehicle control device 100.

For example, when the vehicle has passed a weight measuring device while the vehicle is traveling, a current loading amount may be updated by receiving information about the weight from the measuring device.

The environment sensing device 120, which is a sensor for sensing an external environment of the vehicle, may acquire information associated with the vehicle other than a vehicle body. Such environment sensing device 120 may sense weather information, temperature information, wind strength, dynamics information about an air flow, and the like. In addition, the environment sensing device 120 may also be implemented as an input device for acquiring the weather information, the temperature information, and the information about the wind strength from an external server or the like and inputting the information to the vehicle control device 100, or may include a receiving device for receiving the corresponding information.

As described above, in a case of the vehicle carrying the load such as the cargo or the passenger, traveling of such vehicle is affected by the weight of the load, and in particular, the weight of the vehicle increases during deceleration or acceleration. This is referred to as an acceleration or deceleration-related weight, and in general, a weight of a large vehicle increases by about 7% and a weight of a general vehicle increases by about 5%.

Braking of the vehicle is performed by a frictional force of a brake, and a brake performance of the vehicle (e.g., a frictional force between a brake pad and a disk) is limited.

Thus, a braking distance in consideration of the weight of the vehicle may be derived through the following Equations 1 and 2.

$$\begin{matrix}\frac{1}{2} * \frac{W + Δ W}{{gv}^{2}} = Σ F * S & [ Equation 1 ] \\ \begin{matrix}S = \frac{W + Δ W}{2 g Σ F} * {( \frac{V}{3.6} )}^{2} \\ = \frac{{V}^{2}}{254} * ( W + Δ W ) \text{/} Σ F\end{matrix} & [ Equation 2 ]\end{matrix}$$

In Equation 1 and Equation 2, v is a braking initial velocity (m/s), V is a braking initial velocity (km/h) in a different unit, F is a frictional force (kgf), ΣF is a brake frictional force sum (kgf), S is a braking distance (m), u is a rolling resistance coefficient, g is an acceleration of gravity (9.8 m/s²), and W is a vehicle weight (kgf). Further, the acceleration or deceleration-related weight applied to the large vehicle is represented as ΔW=0.07 W (applied as 7%).

As in Equation 2, the braking distance S is proportional to the weight of the vehicle (W+ΔW), and is proportional to the square of velocity V².

As such, because the braking distance is changed based on the weight, that is, a change in the weight, a weight value may be assigned to a parameter for a traveling pattern of a driver to be described below accordingly, and a similar traveling pattern may be found.

Further, similar to the above equations, various equations associated with the weight of the vehicle may be derived in consideration of influences of a gradient, a curvature, and weather. That is, a correlation and a parameter weight value based on the weight change of the vehicle may be derived.

The traveling pattern generator 130 generates the traveling pattern of the driver in consideration of a vehicle status based on the velocity and the weight, a road condition based on a traveling route, and a driving habit of the driver traveling the traveling route. That is, the traveling pattern generator 130 patterns and stores a propensity of the driver through the information acquired from the vehicle sensing device no or the environment sensing device 120.

Various parameters may be associated with such traveling pattern, and a weight value for calculating the slowing down length may be assigned to each of the parameters. A unique ID may be assigned to each traveling pattern composed of the plurality of parameters, so that a similarity of the traveling pattern may be determined and updated for each traveling of the driver.

A table below shows traveling patterns of the driver in consideration of various parameters by way of example.

TABLE 1

| | | | | | | | | | | Entry | | | | | | |
|---|---|---|---|---|---|---|---|---|---|---|---|---|---|---|---|---|
| | Guide | | | | | | | | | and exit | | | Distance | | Average | |
| Pattern | weight | | Vehicle | Initial | Final | Speed | Point | Point | Guide | link | | Temper- | to vehicle | | brake | |
| ID | value | | weight | velocity | velocity | limit | curvature | gradient | type | angles | Weather | ature | ahead | | percentage | . . . |
| 1 | +30 | m | 5000 kg | 100 kph | . . . | 30 | 20 | 80 | Left | 90 | Sunny | 20 | 1000 | m | 50% | . . . |
| | | | | | | | | | turn | | | | | | | |
| 2 | +100 | m | 5000 kg | . . . | 40 kph | 40 | 20 | 80 | Left | 90 | Sunny | 20 | 1000 | m | 50% | . . . |
| | | | | | | | | | turn | | | | | | | |
| 1-1 | +200 | m | . . . | . . . | 65 kph | 60 | . . . | . . . | . . . | . . . | . . . | . . . | . . . | | . . . | . . . |
| 2-1 | +150 | m | . . . | . . . | . . . | . . . | . . . | . . . | Right | . . . | . . . | . . . | . . . | | . . . | . . . |
| | | | | | | | | | turn | | | | | | | |
| 3 | +20 | m | . . . | . . . | . . . | 30 | 100 | −100 | U-turn | 180 | Sunny | 30 | 100 | m | 80% | . . . |

As shown in Table 1, each ID may be assigned to each pattern, so that the traveling patterns may be compared with other traveling patterns. Further, a slowing down length weight value for each pattern may be set in consideration of a plurality of parameters such as a vehicle weight, an initial velocity, a final velocity, a speed limit, a point curvature, a point gradient, a traveling guide type, entry and exit link angles, weather, a temperature, a distance to a vehicle ahead, an average brake percentage, and the like.

The slowing down length calculator 140 according to the present embodiment may calculate the slowing down length weight value based on the weight and the traveling pattern, and may calculate the slowing down length of the vehicle based on the traveling pattern and the slowing down length weight value.

FIG. 2 is a view for illustrating a slowing down length change based on a vehicle weight according to an embodiment of the present disclosure.

As shown, when the vehicle enters a section that requires the deceleration of the vehicle, such as a downhill road, a turning section, an entry section, and the like, the corresponding point may be regarded as a point at which deceleration information guidance occurs.

When the vehicle enters the deceleration section where the deceleration is required, the traveling pattern generator 130 and the slowing down length calculator 140 may determine whether the same or similar traveling pattern exists among previously stored traveling patterns, and calculate the slowing down length based on a slowing down length weight value, which was applied to the same or similar traveling pattern.

The slowing down length may be defined as a moving distance of the vehicle from a time point when the driver operates the brake for the deceleration or from a time point when an accelerator operation is stopped to a deceleration end time point when stopping the brake operation again or resuming the accelerator operation. Such slowing down length may vary based on the weight of the vehicle. As in Equation 2, as the weight of the vehicle increases, the slowing down length increases, and the slowing down length weight value in Table 1 increases.

The slowing down length calculator 140 may adjust the slowing down length weight value based on an actual slowing down length of the driver. In addition, the traveling pattern generator 130 may update such adjusted slowing down length weight value and the traveling pattern by assigning the weight value to the parameter constituting the traveling pattern.

As described above, the various equations associated with the parameters such as the gradient, the curvature, and the weather influences, and the weight of the vehicle may be derived, and the weight value of the parameter may be updated based on such adjustment of the slowing down length.

In addition, the traveling pattern generator 130 may determine a pattern similarity based on the adjusted weight value and parameter weight value, and the traveling pattern may be updated based on the similarity.

In one example, the slowing down length calculator 140 according to the present embodiment may calculate the slowing down length weight value in consideration of the external environment sensed by the environment sensing device 120. For example, when information about a tire condition and a road surface condition sensed from the vehicle sensing device no and the environment sensing device 120 is acquired, the slowing down length calculator 140 may derive a friction coefficient for the vehicle brake based on the tire condition and the road surface condition, and may calculate a deceleration weight value based on the derived friction coefficient.

In one example, when the vehicle is a bus, the weight may be sensed based on the number of passengers in the bus, and the slowing down length calculator 140 may calculate the deceleration weight value based on the weight of the passengers.

The deceleration information about the slowing down length or the deceleration time point thus derived is provided to the driver by the user interface 15o. The user interface 150 may include a navigation mounted in the vehicle or implemented as a mobile device of the driver, and may be implemented as various digital devices including a display and an audio for guiding a driver to the road.

The user interface 150 performs a role of a conventional navigation, and informs the driver of information derived from the traveling pattern generator 130 and the slowing down length calculator 140 when the deceleration or the acceleration is required depending on a condition of the road to be traveled, that is, when the vehicle enters a section requiring shifting.

In one example, the slowing down length calculator 140 may calculate the deceleration weight value and the slowing down length and perform route research in advance only when the vehicle enters the deceleration section requiring the deceleration and the deceleration by the driver is not performed.

In other words, when it is determined that the vehicle is decelerating based on the traveling pattern when the vehicle entered the deceleration section requiring the deceleration, deceleration guidance may not be provided to the driver.

Hereinafter, a vehicle control method according to an embodiment of the present disclosure will be described in detail with reference to FIG. 3. FIG. 3 is a control flowchart illustrating a vehicle control method according to another embodiment of the present disclosure.

Hereinafter, it is assumed that the vehicle control device 100 of FIG. 1 performs processes of FIG. 3. In addition, in a description of FIG. 3, an operation described as being performed by the device may be understood to be controlled by the traveling pattern generator 130 and the slowing down length calculator 140 of the vehicle control device 100. The traveling pattern generator 130 and the slowing down length calculator 140 may be combined with each other as one controller, and implemented as one hardware chipset or the like.

As shown, first, the vehicle sensing device 110 senses the information about the vehicle including the velocity and the weight of the vehicle (S310).

The information about the vehicle may include not only the information about the interior of the vehicle or the vehicle itself, but also the external environment information of the vehicle, and the information about the external environment may be obtained through the environment sensing device 120.

Then, the traveling pattern of the driver may be generated in consideration of the vehicle state based on the velocity and the weight of the vehicle, the road condition based on the traveling route, and the driving habit of the driver traveling the traveling route (S320).

The traveling pattern may be composed of the plurality of parameters, as described above. Each of the plurality of parameters may be calculated from the equation associated with the weight of the vehicle. Such a parameter may be assigned the weight value based on the weight-based slowing down length.

The slowing down length calculator 140 may calculate the slowing down length weight value based on the weight and the traveling pattern, and calculate the slowing down length of the vehicle based on the traveling pattern and the slowing down length weight value (S330).

The slowing down length weight value may be calculated based on the external environment, for example, the tire condition and the road surface condition, and the friction coefficient of the brake may be adjusted based on such external environmental information.

Then, the user interface 150 may provide the deceleration information to the driver based on the slowing down length, and for example, may inform the deceleration time point (S340).

When the deceleration occurs by the driver, the slowing down length weight value may be adjusted based on the actual slowing down length of the driver, and the traveling pattern may be updated by assigning the weight value to the parameter constituting the traveling pattern based on the adjusted weight value (S350).

In one example, according to the present embodiment, when the vehicle enters the deceleration section requiring the deceleration and the deceleration by the driver is not performed, only the deceleration weight value and the slowing down length may be calculated.

FIG. 4 is a control flowchart illustrating a vehicle control method according to another embodiment of the present disclosure.

As described above, the vehicle control device according to embodiments of the present disclosure calculates a guide weight value, that is, the slowing down length weight value, to be provided to the driver based on the traveling pattern, and adjusts a guide distance, that is, the slowing down length. After a final guidance is completed, a current traveling pattern may be learned, and an existing pattern may be corrected or a new pattern may be generated. This will be described with reference to FIG. 4.

When a guide point occurs, that is, when the vehicle enters the point requiring the deceleration of the vehicle, first, it is determined whether there is the same traveling pattern in consideration of the weight corresponding to the guide point (S401).

That is, it is determined whether there is a traveling pattern in consideration of currently sensed internal and external environments of the vehicle and the weight of the vehicle, among the previously stored traveling patterns.

As a result of the determination, when there is no traveling pattern in consideration of the weight of the vehicle, it may be determined whether there is the same traveling pattern except for the weight (S402).

When there is the same traveling pattern except for the weight, the weight value based on the change of the weight is calculated and reflected in the traveling pattern (S403), and then it may be determined whether there is the same traveling pattern once again (S404).

The weight value may be the weight value for the parameter constituting the traveling pattern, or may be the weight value for the slowing down length that reflects the parameter weight value.

When there is the traveling pattern to which the weight value for the weight is reflected, the slowing down length calculator 140 may calculate the slowing down length based on the traveling pattern (S405), and the user interface 150 may provide such deceleration information to the driver (S406).

After the deceleration information is provided to the driver as described above, the traveling pattern may be updated, that is, renewed by reflecting a parameter change amount (S407).

In S401, when there is the same pattern in consideration of the weight for the guide point, the slowing down length based on the traveling pattern may be calculated immediately (S405).

On the other hand, when the same traveling pattern except the weight does not exist in S402, or when the same traveling pattern does not exist in S404, the slowing down length calculator 140 may determine whether a similar traveling pattern exists (S408). If multiple similar traveling patterns exist, the slowing down length calculator 140 may determine the most similar traveling pattern.

When the similar traveling pattern exists, the slowing down length corresponding to the existing traveling pattern may be calculated (S409), and such deceleration information may be provided to the driver (S410).

Then, subsequently, the parameter change amount may be measured (S411), a similarity ratio of the traveling pattern may be derived based on the changed parameter, and the weight value of the parameter may be updated based on such similarity ratio (S412).

In S408, when even the similar traveling pattern does not exist, the slowing down length calculator 140 may calculate a preset default slowing down length (S413).

When the slowing down length is calculated, similar to the above, the deceleration information may be provided to the driver (S414), and the parameter change amount may be measured (S415). Then, a new traveling pattern may be generated based on the measured parameter (S416).

In summary, the calculating of the slowing down length according to the present embodiment may include, when the vehicle enters the deceleration section requiring the deceleration, determining whether the same or similar traveling pattern exists among the previously stored traveling patterns, and calculating the slowing down length based on the slowing down length weight value, which was applied to the same or similar traveling pattern. That is, the slowing down length may be adjusted using the slowing down length weight value based on the traveling pattern of the driver. When the final guidance is completed, the current traveling pattern may be learned, and the existing pattern may be corrected or the new pattern may be generated.

In one example, updating of the traveling pattern may include determining a pattern similarity based on the adjusted weight value and the parameter weight value, and updating the traveling pattern based on the similarity.

FIG. 5 is a control flowchart illustrating a traveling pattern learning method according to an embodiment of the present disclosure.

First, when the vehicle enters the guide point, the current traveling pattern of the vehicle is identified based on the state of the vehicle or a scheduled guide, and the traveling pattern generator 130 or the slowing down length calculator 140 may compare the traveling patterns with each other to determine whether there is the same or similar pattern (S510).

When the same or very similar traveling pattern is derived through the comparison between the traveling patterns, correspondingly, the deceleration information to which the slowing down length weight value is applied may be provided to the driver.

Then, a similarity between the derived traveling pattern and the traveling pattern based on the current vehicle state and the substantial slowing down length may be calculated (S520).

Then, a similarity weight value for the parameter may be calculated based on the calculated similarity (S530), and the traveling pattern may be updated by reflecting the calculated similarity weight value for the parameter (S540).

As described above, when the similarity between the traveling patterns is equal to or greater than a preset threshold value X % as the similarity comparison result, the corresponding derived pattern may be updated by assigning the weight value thereto.

For example, when the actual traveling pattern of the driver and the pre-stored traveling pattern are values similar to each other by 95% or greater on average, a currently occurring value may be combined with an existing value at a ratio of 5%.

In this connection, when other parameters are the same but only a value for a particular parameter is different, the value for the particular parameter may be patterned for a later situation and only a difference value may be stored. The traveling pattern generator 130 may check and store patterns in an order starting from a pattern having a small parameter difference to a pattern having a large parameter difference.

In addition, even for the patterns in which only the difference values are used as the traveling patterns, the traveling pattern may be updated by reflecting a traveling habit, a change in vehicle characteristics, and the like.

In one example, an update counter for the number of update times may be set, and the traveling pattern may be learned by increasing a ratio of a generated value when a specific parameter is frequently updated.

In this connection, the traveling pattern generator 130 may organize the traveling pattern that has become the same by periodically organizing the patterns.

The update of the number of parameters, the change in the form, and the traveling pattern may be performed at regular intervals, for example, in seconds, rather than a time point when the shift is required.

As described above, according to embodiments of the present disclosure, the device and the method for controlling the vehicle that may consider the ordinary traveling pattern of the driver, and learn the pattern based on the weight and the situation to provide the appropriate guide distance, thereby allowing more comfortable and safe travel are provided.

The description above is merely illustrative of the technical idea of the present disclosure, and various modifications and changes may be made by those skilled in the art without departing from the essential characteristics of the present disclosure.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

Embodiments of the present disclosure provide the device and the method for controlling the vehicle that may perform the appropriate deceleration in consideration of the effect on weight of the vehicle and a re-acceleration time.

Further, an embodiment of the present disclosure provides proper guidance considering the traveling pattern of the driver based on the loading amount and the traveling situation or environment.

Further, an embodiment of the present disclosure provides the device and the method for controlling the vehicle that may store and update the traveling pattern of the driver in consideration of the tire condition of the vehicle, the road surface information, the road information, the weather information, and the like.

In addition, an embodiment of the present disclosure provides the device and the method for controlling the vehicle that do not perform the deceleration guidance in the deceleration state to adaptively change a guide form based on the traveling pattern of the driver.

Therefore, the appropriate guide distance may be provided by considering the ordinary traveling pattern of the driver and learning the pattern based on the weight and the situation, so that the driver may travel more comfortably and safely.

In addition, various effects, directly or indirectly understood through the present specification, may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control device for providing information associated with traveling, the vehicle control device comprising:
a vehicle sensing device configured to sense information about a vehicle, the information including a velocity and a weight of the vehicle;
a traveling pattern generator configured to generate a traveling pattern of a driver in consideration of a vehicle state based on the velocity and the weight, a road condition based on a traveling route, and a driving habit of the driver traveling the traveling route;
a slowing down length calculator configured to calculate a slowing down length weight value based on the weight and the traveling pattern, and calculate a slowing down length of the vehicle based on the traveling pattern and the slowing down length weight value; and
a user interface configured to inform the driver of deceleration information based on the slowing down length.

2. The vehicle control device of claim 1, wherein the slowing down length calculator is configured to adjust the slowing down length weight value based on an actual slowing down length of the driver.

3. The vehicle control device of claim 2, wherein the traveling pattern generator is configured to update the traveling pattern by assigning a weight value to a parameter of the traveling pattern based on the adjusted slowing down length weight value.

4. The vehicle control device of claim 3, wherein the traveling pattern generator is configured to determine a pattern similarity based on the adjusted slowing down length weight value and the parameter weight value and to update the traveling pattern based on the similarity.

5. The vehicle control device of claim 1, further comprising:
an environment sensing device configured to sense an external environment of the vehicle,
wherein the slowing down length calculator is configured to calculate the slowing down length weight value in consideration of the sensed external environment.

6. The vehicle control device of claim 5, wherein:
the sensed information about the vehicle or the sensed external environment of the vehicle includes information about a tire condition and a road surface condition; and
the slowing down length calculator is configured to derive a friction coefficient for a vehicle brake based on the tire condition and the road surface condition, and calculate a deceleration weight value based on the derived friction coefficient.

7. The vehicle control device of claim 1, wherein the slowing down length calculator is configured to determine whether there is a same or similar traveling pattern among previously stored traveling patterns when the vehicle enters a deceleration section requiring deceleration, and calculate the slowing down length based on a slowing down length weight value applied to the same or similar traveling pattern.

8. The vehicle control device of claim 1, wherein the user interface is configured to inform the driver of a deceleration time point on the traveling route.

9. The vehicle control device of claim 1, wherein when the vehicle is a bus, the weight is sensed based on a number of passengers in the bus.

10. The vehicle control device of claim 1, wherein the slowing down length calculator is configured to calculate a deceleration weight value and the slowing down length when the vehicle enters a deceleration section requiring deceleration and deceleration by the driver is not performed.

11. A vehicle control method for providing information associated with traveling, the method comprising:
sensing information about a vehicle, the information including a velocity and a weight of the vehicle;
generating a traveling pattern of a driver in consideration of a vehicle state based on the velocity and the weight, a road condition based on a traveling route, and a driving habit of the driver traveling the traveling route;
calculating a slowing down length weight value based on the weight and the traveling pattern;
calculating a slowing down length of the vehicle based on the traveling pattern and the slowing down length weight value; and
informing the driver of deceleration information based on the slowing down length.

12. The method of claim 11, further comprising adjusting the slowing down length weight value based on an actual slowing down length of the driver.

13. The method of claim 12, further comprising updating the traveling pattern by assigning a weight value to a parameter of the traveling pattern based on the adjusted slowing down length weight value.

14. The method of claim 13, wherein updating the traveling pattern includes determining a pattern similarity based on the adjusted slowing down length weight value and the parameter weight value, and updating the traveling pattern based on the similarity.

15. The method of claim 11, further comprising:
sensing an external environment of the vehicle,
wherein calculating the slowing down length weight value includes calculating the slowing down length weight value in consideration of the sensed external environment.

16. The method of claim 15, wherein:
sensing the information about the vehicle includes sensing a tire condition;
sensing the external environment includes sensing a road surface condition; and
calculating the slowing down length includes deriving a friction coefficient for a vehicle brake based on the tire condition and the road surface condition, and calculating a deceleration weight value based on the derived friction coefficient.

17. The method of claim 11, wherein calculating the slowing down length includes:
determining whether there is a same or similar traveling pattern among previously stored traveling patterns when the vehicle enters a deceleration section requiring deceleration; and
calculating the slowing down length based on a slowing down length weight value applied to the same or similar traveling pattern.

18. The method of claim 11, wherein informing the driver of the deceleration information includes informing the driver of a deceleration time point on the traveling route based on the slowing down length.

19. The method of claim 11, wherein sensing the information about the vehicle includes, when the vehicle is a bus, deriving the weight based on a number of passengers in the bus.

20. The method of claim 11, wherein a deceleration weight value and the slowing down length are calculated when the vehicle enters a deceleration section requiring deceleration and deceleration by the driver is not performed.
